(19) United States
(12) Patent Application Publication
(10) Pub. No.: US 2013/0346023 A1
(43) Pub. Date: Dec. 26, 2013

(54) SYSTEMS AND METHODS FOR UNMIXING DATA CAPTURED BY A FLOW CYTOMETER

(71) Applicants: Purdue Research Foundation, West Lafayette, IN (US); De Novo Software LLC, Los Angeles, CA (US)

(72) Inventors: David Novo, Los Angeles, CA (US); Bartlomiej Rajwa, West Lafayette, IN (US)

(21) Appl. No.: 13/925,575

(22) Filed: Jun. 24, 2013

Related U.S. Application Data
(60) Provisional application No. 61/662,916, filed on Jun. 22, 2012.

(30) Foreign Application Priority Data
Jun. 21, 2013 (US) PCT/US13/47132

(51) Int. Cl. G06F 17/00; G06F 17/18

(52) U.S. Cl. CPC G06F 17/00; G06F 17/18
USPC 702/179; 702/189

(57) ABSTRACT

Systems and methods for obtaining fluorochrome abundance information by unmixing fluorescence emission data captured by a flow cytometer in accordance with embodiments of the invention are disclosed. In one embodiment, a data analysis system includes a processor, a memory, and an optical data analysis application, wherein the optical data analysis application configures the processor to obtain control optical data, generate a mixing model using the obtained control optical data and a system of linear combinations, obtain experimental optical data for particles stained with a set of fluorochromes, and estimate abundances of the fluorochromes in the set of fluorochromes using the obtained experimental optical data by solving a system of equations to unmix the optical data, where the number of equations is larger than the number of unknowns, based upon the generated mixing model using an unmixing process that accounts for increased noise variance with increased fluorochrome abundance.

### CROSS-REFERENCE TO RELATED APPLICATIONS

The current application claims priority to Provisional Patent Application No. 61/662,916, filed Jun. 22, 2012, titled “Systems and Methods for Unmixing Data Captured by a Flow Cytometer” the disclosure of which is incorporated herein by reference.

### BACKGROUND

The present invention relates generally to the field of flow cytometry and more specifically to determining the abundance of fluorochromes in flow cytometry.

Flow cytometry is a powerful cell-analysis technique, applied in various fields of life science ranging from basic cell biology to genetics, immunology, molecular biology, microbiology, plant cell biology, cancer diagnosis and environment science. Flow cytometry involves generating a stream of biological particles (bioparticles) that pass in single file through a beam of light (usually generated by one or more lasers having separate frequencies). As bioparticles pass through the beam, the beam is scattered producing light-scatter pattern dependent on particle structure, shape, and physical composition. Additionally fluorescent, phosphorescent, or Raman-scattering chemicals found in, or attached to, the bioparticle may be excited into emitting light. Depending on the type of optical process the signal emitted by the chemical species can be at a longer wavelength than the light source—in the case of linear optics, or shorter—in the case of nonlinear optical phenomena as two-photon excitation. In typical flow cytometry instruments forward-angle light scatter (size-related) and side-angle light scatter (shape- and structure-related) as well as various fluorescence emissions are collected following illumination/excitation. The data are collected, digitized, and stored on a computer where they can be further processed to discriminate subpopulations of bioparticles (cells) with similar characteristics from within the original heterogeneous sample. By analyzing the intensity of the detected light, it is possible to derive various types of information about the physical and chemical structure of each bioparticle.

A wide range of fluorochromes can be used to stain or label bioparticles. Fluorochromes are typically attached to an antibody that recognizes a target feature on or in a bioparticle, or chemical entity with affinity for a cell membrane or another structure of a bioparticle. Each fluorochrome typically has a characteristic excitation and emission spectra, and the emission spectra of different fluorochromes used in a single sample often overlap.

Common flow cytometry implementations assume that the signal from every individual fluorochrome should be collected using an independent detector. The optical pathway of flow cytometry instruments is arranged to separate signals from different fluorochromes and route them into dedicated detectors; however, owing to spectral overlap and imperfection of filters a complete separation is almost never possible. Therefore, the fluorescence emitted by every fluorochrome may be simultaneously collected by more than one detector (in an extreme case, all the detectors).

Both the absorption and emission spectra of the fluorochromes used in flow cytometry carry valuable spectral information about tagged bioparticles. The commonly used optical design of flow cytometry instruments make it desirable to have a series of efficient fluorochromes that have very specific and narrow excitation maxima within the sensitivity of an individual detector. The flow cytometry systems efficiently collect optical signals emitted by individual bioparticles, and convert them quantitatively into values that can be related to biological phenomena of interest. Flow cytometry instruments have developed from single-detector systems to devices having a plurality of detectors, hence capable of collecting signals from a number of chemical species simultaneously. More recently, the use of detector arrays with more than 30 detectors has been demonstrated. The arrays may be implemented as multianode photomultipliers (PMT), or linear charge couple devices (CCD). However, the vast majority of commercial systems are able to collect from 5 to 7 simultaneous emitted signals, plus two or more light-scatter related measurements. Flow cytometers capable of collecting multiple signals are often referred to as polychromatic flow cytometers.

In traditional polychromatic flow cytometry, the number of employed detectors is equal to the number of investigated labeled markers. Since the process of spectral overlap occurring during the measurement can be mathematically represented as linear mixing, the abundances (or values linearly correlated with abundances) are calculated by an unmixing operation that multiplies the measured data vectors (or raw fluorescence observations) by the inverse of the mixing (“spillover”) matrix. Although the mixing matrices are a priori unknown, they can be easily approximated by employing single-stained controls—that is by performing measurements of samples labeled by one fluorochrome at a time, and normalizing the resultant spectra in an appropriate fashion. This process leading to the recovery of abundances is known as flow cytometry compensation, and is well described in flow cytometry literature.

The data generated by a flow cytometer is typically formatted in accordance with the Flow Cytometry Standard (FCS), which enables analysis of the data using software applications such as FCS Express provided by De Novo Software LLC of Los Angeles, Calif. Analysis that can be performed using such software involves the generation of one dimensional and two dimensional plots. In addition to plots, the software enables the generation of plot overlays and gates, which are used to generate statistics describing the observed populations of bioparticles. The analysis strategy and results derived from it are stored in an electronic document referred to as a layout file. Layout files can also optionally contain the raw data used to generate the results.

### SUMMARY OF THE INVENTION

Systems and methods for obtaining fluorochrome abundance information by unmixing fluorescence emission data captured by a flow cytometer in accordance with embodiments of the invention are disclosed. In one embodiment, a data analysis system is configured to analyze optical data captured by a flow cytometer with respect to a plurality of particles stained with a plurality of fluorochromes, where an optics and detection system within the flow cytometer separates optical emission with respect to spectral ranges and where at least one detector is used to capture a number of optical measurements that is greater than the plurality of fluorochromes used to stain the plurality of particles, where the data analysis system includes a processor, a memory connected to the processor and configured to store an optical data analysis application, wherein the optical data analysis application configures the processor to: obtain control optical data for at least one particle stained with at least one fluorochrome selected from a set of fluorochomes, where the control optical data is captured by the flow cytometer configured so that an optics and detection system within the flow cytometer separates optical emission with respect to a predetermined set of spectral ranges, generate a mixing model using the obtained control optical data and a system of linear combinations, obtain experimental optical data for particles stained with the set of fluorochromes, where the experimental optical data is captured by the flow cytometer configured so that an optics and detection system within the flow cytometer separates optical emission with respect to the predetermined spectral ranges using at least one detector configured to capture a number of optical measurements and the number of optical measurements is greater than the number of fluorochromes in the set of fluorochromes, and estimate abundances of the fluorochromes in the set of fluorochromes using the obtained experimental optical data by solving an overdetermined system of equations to unmix the optical data, based upon the generated mixing model that accounts for increased noise variance with increased fluorochrome abundance.

In a further embodiment, the optical data analysis application further configures the processor to obtain control optical data for the at least one particle stained using a single fluorochrome selected from the set of fluorochromes.

In another embodiment, the optical data can be captured from optical signals that can be selected from the group of fluorescence signals, Raman signals, and phosphorescence signals.

In a still further embodiment, each of the number of detectors is tuned to capture optical emissions over a spectrum as wide as allowed by the flow cytometer.

In still another embodiment, the optical data analysis application further configures the processor to estimate fluorochrome abundances by utilizing a percentage error estimation via a weighted least squares method.

In a yet further embodiment, the optical data analysis application further configures the processor to estimate fluorochrome abundances by utilizing a percentage errors minimization process.

In yet another embodiment, the optical data analysis application further configures the processor to estimate fluorochrome abundances by utilizing a mean absolute percentage errors minimization process using:

\hat{α}=(M^{T}W²M)⁻¹M^{T}W²r

where \hat{α} is a vector of length p of the estimated fluorochrome abundances where p is the number of fluorochromes used to stain the particles, M is an L×p spectral-signature matrix where L is the number of optical data observations and p is the number of fluorochromes used to stain the particles, M^{T} is the transpose of the matrix M, r is a normalized vector of length L of optical data observations, and W is a diagonal matrix with 1/rⱼ values such that:

$$W = ( \begin{matrix}\frac{1}{{r}_{1}} & 0 & 0 \\ 0 & ⋱ & 0 \\ 0 & 0 & \frac{1}{{r}_{L}}\end{matrix} )$$

In a further embodiment again, the optical data analysis application further configures the processor to estimate fluorochrome abundances by utilizing a maximum likelihood-based Poisson regression using:

$$\hat{α} = arg {min}_{α} \{ 2 {j}^{T} ( r \cdot log ( \frac{r}{M α} ) - ( r - M α ) ) + λ \vert {‖ r ‖}_{1} - {‖ α ‖}_{1} \vert \}$$

$$s . t . α > 0$$

where \hat{α} is a vector of length p of the estimated fluorochrome abundances where p is the number of fluorochromes used to stain the particles, j is an L×1 sum vector of 1 where L is the number of optical data observations, and j^{T} is the transpose of the vector j, r is a normalized vector of length L of optical data observations, operator o denotes element-wise multiplication, a is a vector of length p of fluorochrome abundances where p is the number of fluorochromes used to stain the particles, M is an L×p spectral-signature matrix where L is the number of optical data observations and p is the number of fluorochromes used to stain the particles, and λ is a penalty parameter that allows for control of the level of certainty in the model.

In another embodiment again, the optical data analysis application further configures the processor to estimate fluorochrome abundances by minimizing Pearson residuals using:

$$\hat{α} = arg {min}_{α} \{ {j}^{T} ( \frac{{( r - M α )}^{2}}{M α} ) \} s . t . α > 0 ,$$

where \hat{α} is a vector of length p of the estimated fluorochrome abundances where p is the number of fluorochromes used to stain the particles, j is an L×1 sum vector of 1 where L is the number of optical data observations, and j^{T} is the transpose of the vector j, and M is an L×p spectral-signature matrix where L is the number of optical data observations and p is the number of fluorochromes used to stain the particles.

In a further additional embodiment, the optical data analysis application further configures the processor to estimate fluorochrome abundances by utilizing a Bar-Lev/Enis class of transformations and using:

$$\hat{α} = arg {min}_{α} {‖ {𝒜}_{a , b} ( r ) - {𝒜}_{a , b} ( M α ) ‖}_{2}^{2} s . t . α > 0$$

where \hat{α} is a vector of length p of the estimated fluorochrome abundances where p is the number of fluorochromes used to stain the particles, r is a normalized vector of length L of optical data observations, M is an L×p spectral-signature matrix where L is the number of optical data observations and p is the number of fluorochromes used to stain the particles, α is the vector of length p where p is the number of fluorochromes used to stain the particles, and the Bar-Lev/Enis transformation is defined as:

$${𝒜}_{a , b} ( x ) = ( x + 2 a - b ) {( x + a )}^{\frac{1}{2}} , \\ {𝒜}_{a , b , c} ( x ) = {𝒜}_{a , b} ( x ) + {( x + c )}^{\frac{1}{2}} .$$

In another additional embodiment, the processor being configured by the data analysis application to use an unmixing process that accounts for increased noise variance with increased fluorochrome abundance further includes using a regression process in which a distance metric applied to a given optical measurement is weighted by a function of the given optical measurement.

In a still yet further embodiment, the regression process is based upon a noise model selected from the group of Poisson distributed noise, gamma distributed noise, negative binomial distributed noise, and Pólya distributed noise.

In still yet another embodiment, the processor being configured by the data analysis application to use an unmixing process that accounts for increased noise variance with increased fluorochrome abundance further includes using a regression process in which a distance metric applied to a given optical measurement is weighted by a function of the predicted value for the given optical measurement.

In a still further embodiment again, the data analysis application utilizes an iterative percentage errors minimization process.

In still another embodiment again, the least one detector configured to capture a number of optical measurements further comprises of multiple CCD detectors.

In a still further additional embodiment, the least one detector configured to capture a number of optical measurements further comprises a single CCD array detector.

A further embodiment includes, a method for analyzing optical data captured by a flow cytometer with respect to a plurality of particles stained with a plurality of fluorochromes, where an optics and detection system within the flow cytometer separates optical emission with respect to spectral ranges and where at least one detector is used to capture a number of optical measurements that is greater than the plurality of fluorochromes used to stain the plurality of particles, using a data analysis system, the method including: obtaining control optical data for at least one particle stained with at least one fluorochrome selected from a set of fluorochromes using the data analysis system, where the control optical data is captured utilizing the flow cytometer configured so that an optics and detection system within the flow cytometer separates optical emission with respect to a predetermined set of spectral ranges, generating a mixing model using the obtained control optical data using the data analysis system generating a mixing model using the obtained control optical data and a system of linear combinations using the data analysis system, obtaining experimental optical data for particles stained with the set of fluorochromes using the data analysis system, where the experimental optical data is captured utilizing the flow cytometer configured so that an optics and detection system within the flow cytometer separates optical emission with respect to the predetermined spectral ranges using at least one detector configured to capture a number of optical measurements and the number of optical measurements is greater than the number of fluorochromes in the set of fluorochromes, and estimating abundances of the fluorochromes in the set of fluorochromes using the obtained experimental optical data by solving an overdetermined system of equations to unmix the optical data using the data analysis system, based upon the generated mixing model that accounts for increased noise variance with increased fluorochrome abundance.

In a yet further embodiment again, the obtaining control optical data for at least one particle stained with at least one fluorochrome selected from a set of fluorochromes using the data analysis system further includes selecting a single fluorochrome from the set of fluorochromes using the data analysis system.

In yet another embodiment again, the optical data can be captured from optical signals that can be selected from the group of fluorescence signals, Raman signals, and phosphorescence signals using the data analysis system.

In a yet further additional embodiment, each of the number of detectors are tuned to capture optical emissions over a spectrum as wide as allowed by the flow cytometer using the data analysis system.

In yet another additional embodiment, the estimating abundances of the fluorochromes in the set of fluorochromes using the data analysis system further includes utilizing a percentage error estimation via a weighted least squares method using the data analysis system.

In a further additional embodiment again, the estimating abundances of the fluorochromes in the set of fluorochromes using the data analysis system further includes utilizing a percentage errors minimization process using the data analysis system.

In another additional embodiment again, the estimating abundances of the fluorochromes in the set of fluorochromes using the data analysis system further includes using the data analysis system to utilize a mean absolute percentage error minimization process and a formula defined such that:

\hat{α}=(M^{T}W²M)M⁻¹W²r

where \hat{α} is a vector of length p of the estimated fluorochrome abundances where p is the number of fluorochromes used to stain the particles, M is an L×p spectral-signature matrix where L is the number of optical data observations and p is the number of fluorochromes used to stain the particles, M^{T} is the transpose of the matrix M, r is a normalized vector of length L of optical data observations, and W is a diagonal matrix with 1/rⱼ values such that:

$$W = ( \begin{matrix}\frac{1}{{r}_{1}} & 0 & 0 \\ 0 & ⋱ & 0 \\ 0 & 0 & \frac{1}{{r}_{L}}\end{matrix} )$$

In a still yet further embodiment again, the estimating abundances of the fluorochromes in the set of fluorochromes using the data analysis system further includes using the data analysis system to utilize a maximum likelihood-based using a Poisson regression and a formula defined such that:

$$\hat{α} = arg {min}_{α} \{ 2 {j}^{T} ( r \cdot log ( \frac{r}{M α} ) - ( r - M α ) ) + λ \vert {‖ r ‖}_{1} - {‖ α ‖}_{1} \vert \}$$

$$s . t . α > 0$$

where \hat{α} is a vector of length p of the estimated fluorochrome abundances where p is the number of fluorochromes used to stain the particles, j is an L×1 sum vector of 1 where L is the number of optical data observations, and j^{T} is the transpose of the vector j, r is a normalized vector of length L of optical data observations, operator o denotes element-wise multiplication, α is a vector of length p of fluorochrome abundances where p is the number of fluorochromes used to stain the particles, M is an L×p spectral-signature matrix where L is the number of optical data observations and p is the number of fluorochromes used to stain the particles, and λ is a penalty parameter that allows for control of the level of certainty in the model using the data analysis system.

In still yet another embodiment again, the estimating abundances of the fluorochromes in the set of fluorochromes using the data analysis system further includes using the data analysis system to minimize Pearson residuals and to utilize a formula defined such that:

$$\hat{α} = arg {min}_{α} \{ {j}^{T} ( \frac{{( r - M α )}^{2}}{M α} ) \} s . t . α > 0 ,$$

where \hat{α} is a vector of length p of the estimated fluorochrome abundances where p is the number of fluorochromes used to stain the particles, j is an L×1 sum vector of 1 where L is the number of optical data observations, and j^{T} is the transpose of the vector j, and M is an L×p spectral-signature matrix where L is the number of optical data observations and p is the number of fluorochromes used to stain the particles.

In a still yet further additional embodiment, the estimating abundances of the fluorochromes in the set of fluorochromes using the data analysis system further includes using the data analysis system to utilize a Bar-Lev/Enis class of transformations and a formula such that:

$$\hat{α} = arg {min}_{α} {‖ {𝒜}_{a , b} ( r ) - {𝒜}_{a , b} ( M α ) ‖}_{2}^{2}$$

$$s . t . α > 0$$

where \hat{α} is a vector of length p of the estimated fluorochrome abundances where p is the number of fluorochromes used to stain the particles, r is a normalized vector of length L of optical data observations, M is an L×p spectral-signature matrix where L is the number of optical data observations and p is the number of fluorochromes used to stain the particles, α is the vector of length p where p is the number of fluorochromes used to stain the particles, and the Bar-Lev/Enis transformation is defined as:

$${𝒜}_{a , b} ( x ) = ( x + 2 a - b ) {( x + a )}^{\frac{1}{2}} , \\ {𝒜}_{a , b , c} ( x ) = {𝒜}_{a , b} ( x ) + {( x + c )}^{\frac{1}{2}} .$$

In still yet another additional embodiment, the processor being configured by the data analysis application to use an unmixing process that accounts for increased noise variance with increased fluorochrome abundance further includes using a regression process in which a distance metric applied to a given optical measurement is weighted by a function of the given optical measurement.

In a yet further additional embodiment again, the regression process is based upon a noise model selected from the group consisting of Poisson distributed noise, gamma distributed noise, Pólya distributed noise, and negative binomial distributed noise.

In yet another additional embodiment again, the processor being configured by the data analysis application to use an unmixing process that accounts for increased noise variance with increased fluorochrome abundance further includes using a regression process in which a distance metric applied to a given optical measurement is weighted by a function of the predicted value for the given optical measurement.

In a still yet further additional embodiment again, the data analysis application further utilizes an iterative percentage errors minimization process.

In still yet another additional embodiment again, the least one detector configured to capture a number of optical measurements further comprises multiple CCD detectors.

In another further embodiment, the least one detector configured to capture a number of optical measurements further comprises a single CCD array detector.

### BRIEF DESCRIPTION OF THE DRAWINGS

FIG. 1 is a system diagram of a data analysis system for acquiring and analyzing flow cytometry data in accordance with an embodiment of the invention.

FIG. 2 is a flow chart illustrating a process for acquiring fluorescence emission data using a flow cytometer to estimate fluorochrome abundances using an unmixing process in accordance with an embodiment of the invention that assumes the error increases with the size of the observed fluorescence signal.

### DETAILED DESCRIPTION OF THE INVENTION

Turning now to the drawings, systems and methods for obtaining fluorochrome abundance information by unmixing fluorescence emission data captured by a flow cytometer in accordance with embodiments of the invention are illustrated. In several embodiments, the flow cytometer is configured as an over-determined system in which the number of detectors that capture fluorescence emission data is greater than the number of fluorochromes used to stain the bioparticles observed by the flow cytometer. In several embodiments, the unmixing process used to estimate fluorochrome abundances from the captured fluorescence emission data specifically addresses the fact that variance in the observed signal is not equal along the dynamic range of the signal but is related to fluorochrome abundance and depends on the magnitude of observed values.

A variety of unmixing processes in accordance with embodiments of the invention can be utilized that estimate fluorochrome abundances from fluorescence emission data in ways that assume noise is related to fluorochrome abundance including (but limited to) processes that approximate fluorochrome abundances utilizing a percentage error estimation via weighted least squares (WLS), processes that utilize a maximum likelihood-based solution directly employing Poisson regression to obtain fluorochrome abundances, processes that involve direct minimization of deviance, and/or minimization of Pearson residuals, and processes that approximate fluorochrome abundances by employing a Bar-Lev/Enis class of transformations. In various embodiments, the unmixing process utilizes a regression process in which a distance metric applied to a given optical measurement is weighted by a function of the given optical measurement. In many embodiments, the regression process is based upon a noise model including (but not limited to) a Poisson distributed noise, gamma distributed noise, Pólya distributed noise, and a negative binomial distributed noise.

In several embodiments, flow cytometers are configured so that individual detectors capture broader bandwidths of the emission spectrum to improve the performance of the unmixing process. In a number of embodiments, residuals generated during the unmixing process can be utilized to gate the flow cytometry data during analysis. Data gather utilizing a variety of unmixing processes in accordance with embodiments of the invention is illustrated and described in the publication titled “Generalized Unmixing Model for Multispectral Flow Cytometry Utilizing Nonsquare Compensation Matrices” published in the Journal of the International Society for Advancement of Cytometry (Cytometry Part A 83A:508-520, 2013), the disclosure of which is incorporated by reference herein in its entirety.

Although much of the discussion that follows involves discussion of unmixing fluorescence emissions data, unmixing processes in accordance with embodiments of the invention can be utilized to estimate abundance information from any of a variety of optical data captured by flow cytometers including but not limited to fluorescence signals, Raman signals, and phosphorescence signals.

In order to better appreciate the significance of considering the relationship between signal variance and the observed signals in a flow cytometer system, the limitations of conventional unmixing processes when applied to over-determined systems are discussed below.

### The Standard Model of Spectral Overlap

The linear-mixture model assumes that multiple signals measured from every particle can be expressed as a linear combination of spectral signatures. Accordingly, the standard mixing model can be represented using a basic linear spectral mixture equation:

r=Mα+e (1)

where r is the normalized vector of length L of observations (digitized readouts from the detectors) for a bioparticle, where L the number of signals output by the detectors employed in the flow cytometry system
M is an L×p spectral-signature matrix (p being the number of fluorochromes used in an experiment),), which is equivalent to a mixing (spillover, spectral) matrix following appropriate normalization,
α is the vector of length p of fluorochrome abundances (or fractional abundances) for the p fluorochromes used to stain the bioparticles, and
e is the vector of length L that denotes noise.

In contrast to imaging, the cytometry formulation of the problem usually does not refer to fractions (fractional abundances) but to an absolute value of abundance, which is often (however incorrectly) called “compensated fluorescence.” It is important to note that the basic spectral-mixing model as expressed by Eq. (1) in the general case is nonidentifiable, and consequently one cannot find a unique solution unless additional constraints and conditions are imposed. In remote sensing, and other imaging applications it is common to state explicitly that e represents additive Gaussian noise with an expected value of zero. In the flow cytometry literature regarding compensation this is not stated; however, the praxis of compensation implicitly makes such an assumption.

If the mixing matrix M is square and no additional constraints are imposed, the choice of distribution does not affect the solution, and the vector a can easily be found, producing the result known from standard cytometry practice:

α=rM⁻¹ (2)

If the error e represents additive Gaussian noise with an expected value of zero, and the number of detectors is larger than the number of collected signals, the spectral unmixing is performed by solving a least-squares problem:

$${min}_{α ∈ •} \{ {( r - M α )}^{T} ( r - M α ) \} \qquad ( 3 )$$

Assuming no additional constraints, the linear unmixing process that attempts to recover a least-square approximation value of α is represented by the following closed-form equation:

\hat{α}=(M^{T}M)⁻¹M^{T}r (4)

Unfortunately, it is a common observation with flow cytometry data that the resulting least-square approximation value of α obtained using the above approach typically includes negative values for abundances that have no physical interpretation (as it is obvious that it is impossible to have negative fluorescence signal, or negative abundance). The problem is particularly acute with respect to weak fluorescence emission (such as but not limited to autofluorescence), which can be pushed below zero when minimizing for least squares error.

In order to avoid a solution that includes negative fluorochrome abundances, constraints can be imposed upon the unmixing process to ensure that all abundances are nonnegative. This constraint results in the following minimization problem for each particle:

$${min}_{α} \{ {( r - M α )}^{T} ( r - M α ) \} \\ s . t . α \geq 0 \qquad ( 5 )$$

Additionally, it is common in many applications to require that the fractional abundances sum to 100% of the total signal.

The above expression does not have a closed form solution and so numerical techniques can be utilized to solve for the estimated fluorochrome abundances. Due to the constraints, impossible solutions are eliminated. A comparison of the unmixed results using equation (5) with simulated data demonstrates that the computed result is not, however, a good approximation of the true fluorochrome abundances, if the distribution of noise is not strictly Gaussian.

### Signal Variance in Flow Cytometry Systems

The unconstrained and constrained least squares approximation techniques described above have the implicit assumption that the variance of the signal is stable across the whole range of observation values and will return the maximum-likelihood result if the noise distribution is Gaussian. Understanding the source of the observed negative values explains why systems and methods in accordance with embodiments of the invention can obtain significantly better approximations for fluorochrome abundances from over-determined fluorescence emission data. Specifically, systems and methods in accordance with embodiments of the invention do not assume that variance of the signal is stable across the whole range of values. Instead, signal variance is assumed increasing with fluorochrome abundance. As is discussed further below, alternative noise models including (but not limited) to a noise model based upon a Poisson distribution can be utilized to model signal variance in a flow cytometry system. Based on these noise models, and a variety of unmixing processes can be utilized in accordance with embodiments of the invention that assume signal variance increases with increased fluorochrome abundance to achieve more accurate estimates of fluorochrome abundances.

### Modeling Signal Variance in Flow Cytometry Systems

Flow cytometry involves detection of photons emitted by fluorescence molecules on the surface or inside of bioparticles. The detection of emitted photons can be considered to involve Poisson processes. Photons emitted by fluorochromes can be considered to arrive at random time intervals, where the probability that n photons strike a detector in a time interval t is closely approximated by a Poisson distribution. However, even if variance in the photon emission is assumed to be zero and that the photons arriving at the photocathode of a photomultiplier (a commonly used light detector in cytometry) are equally spaced in time, the number of emitted photoelectrons is not constant, as the probability of photoelectron emission is also governed by a Poisson process. Therefore, the expected variance of the signal is not stable, but increases with the abundances of the fluorochromes (i.e. the number of random photon emissions).

In addition, the probability that an emitted photon arrives at a specific detector is dependent upon the energy of the given photon and the filter arrangement used in the flow cytometer. In practice, owing to spectral overlap, two different fluorochromes can emit photons which are very close to each other or identical in terms of energy. Accordingly, a randomly emitted photon may arrive at a detector with a probability P₁, but may end up in another detector with a probability (1−P₁). Therefore the mixing process occurs before the measurement is performed at the detector.

In the ideal case in which no additional noise sources are present and the detector offers 100% efficiency, the simplest model of the fluorescence emission data can be expressed as:

r˜Poisson(Mα) (6)

As noted above, the consequence of the model in equation (6) is that the expected variance of the signal is not stable, and increases with the fluorochrome abundances.

The goal of unmixing is to gain knowledge regarding the contribution of different fluorochromes to the total measured signal. The visualization approach commonly used in flow cytometry involving scatter plots, as well as the traditional terminology describing samples as “positive” or “negative,” suggests that practitioners are interested in minimizing the error of estimation for low-intensity signals (“negative” population) just as much as for high-intensity signals (“positive” population) when both are present in the mixture. The reason is that for Boolean classification of cells the “negative” and “positive” categories are equally important. Accordingly, unmixing processes in accordance with embodiments of the invention specifically address the fact that variance in the observed signal is not equal along the dynamic range but depends on the magnitude of observed values. Therefore, systems and methods in accordance with many embodiments of the invention consider the magnitude of an error in relation to the size of the observed fluorescence signal. Otherwise the error minimization can focus on estimating the “positive” sub-populations, at the cost of neglecting the correct estimation of abundances in “negative” sub-populations.

A variety of techniques for unmixing fluorescence emission signals are discussed below including (but limited to) processes that approximate fluorochrome abundances utilizing a percentage error estimation via weighted least squares (WLS), processes that utilize a maximum likelihood-based solution directly employing Poisson regression to obtain fluorochrome abundances, processes that involve direct minimization of deviance, and/or minimization of Pearson residuals, and processes that approximate fluorochrome abundances by employing a Bar-Lev/Enis transformation. Various processes for unmixing fluorescence emission data to obtain fluorochrome abundances in accordance with embodiments of the invention are discussed further below.

### Unmixing Using Weighted Least-Squares and Percentage Error Estimation

In several embodiments, the unmixing process assumes that the observations came from a normal distribution. However, an additional assumption is made that signal variance in the Gaussian model grows with signal intensity. Consequently, measurements with lower variance have proportionally more influence on abundance estimates than measurements with higher variance. In a number of embodiments, the unmixing process involves performing a percentage errors minimization process.

In several embodiments, a mean absolute percentage error (MAPE) minimization is performed. A MAPE minimization defines percentage error as (observed value−predicted value)/(predicted value). Since the predicted value is the value that the process aims to find, the minimization can be performed as an iterative process. In certain embodiments, an iterative reweighted least squares (IRLS) process is used to perform the iterations.

An alternative formulation of MAPE defines this value as (observed value−predicted value)/(observed value). Owing to this reformulation, a closed-form solution which minimizes MAPE can be found. Using this alternative formulation, the error Eₚ can be redefined as:

$${E}_{p} = \frac{1}{n} {‖ \frac{r - M α}{r} ‖}_{1}$$

where n is the number of elements in vector r, and

$$\frac{x}{y}$$

is the Hadamard division (or element by element division) of the vectors x and y.

The minimization problem can be rewritten as:

$${min}_{α} \{ {( Wr - WM α )}^{T} ( Wr - WM α ) \}$$

where W is a diagonal matrix with 1/rⱼ values:

$$W = ( \begin{matrix}\frac{1}{{r}_{1}} & 0 & 0 \\ 0 & ⋱ & 0 \\ 0 & 0 & \frac{1}{{r}_{L}}\end{matrix} )$$

The term that is minimized can be rewritten as:

(Wr−WMα)^{T}(Wr−WMα)=(Wr)^{T}Wr−(Wr)^{T}WMα−(WMα)^{T}Wr+α^{T}M^{T}W²Mα

In order to find a closed-form solution, the above term is differentiated with respect to the abundances vector and equated to zero:

−(Wr)^{T}WM+M^{T}W²Mα=0

The solution for the above equation provides the following estimation of α:

\hat{α}=(M^{T}W²M)⁻¹M^{T}W²r

The weights in the matrix W are inversely proportional to the signal, providing a simple solution that recognizes that the increase of variance (uncertainty) increases with the signal. The MAPE minimization yields a closed form solution that can be utilized in an unmixing process in accordance with embodiments of the invention. An alternative to MAPE and other least squares approximation methods is to utilize a generalized linear model, which explicitly allows for various non-Gaussian distributions of the random component.

### Unmixing Processes Utilizing Generalized Linear Models

Generalized linear model processes in accordance with embodiments of the invention attempt to fit observed fluorescence emission data by the method of maximum likelihood estimation instead of least squares approximation techniques. Accordingly, generalized linear models can be utilized to perform unmixing where the noise is assumed not normally distributed.

Signal formation can be seen as a stochastic Poisson process. Therefore, it is expected that distribution of noise will be well approximated by a Poisson distribution. However, this simplest approximation typically does not represent the experimental reality very well. Flow cytometry instruments are usually not equipped with detectors capable of counting photons and reporting them directly, but rather convert light into analog electronic signals (even though this information is subsequently digitized). Therefore the “raw” readout is represented as real rather than natural numbers.

The assumption of purely Poisson-distributed flow cytometer data is also a problem for in-silico experiments and simulations. If no mixing occurs, a simulation utilizing a Poisson random-number generator produces only integer values illustrating the number of photons, and then the number of photoelectrons generated at each detector. The mixing process indeed generates real numbers as an artifact of matrix multiplication, but these are subsequently truncated when processed by a Poisson random-number generator when the detection step is simulated. A simplistic solution for the purpose of simulation might involve the addition of white noise to the Poisson signal. However, the true fluorescence emission signals collected using a flow cytometer would be continuous even if no readout noise was present.

Simulating the true continuous distribution of analog signals produced by a photo multiplier tube is quite difficult, as the Poisson model is not appropriate if the secondary emission statistics are taken under consideration. It has been demonstrated that these effects can be described by the Pólya distribution. However, assuming a completely noiseless secondary emission process in which gain does not vary for different photoelectrons, the fluorescence emission data can be approximated using a simple continuous generalization of a Poisson distribution.

Therefore, the flow cytometer data acquisition can be simulated using a formulation of a Poisson distribution in which the factorial is replaced by a function Gamma:

$${p}_{μ}^{cont} ( y ) = \frac{{μ}^{y} exp ( - μ )}{Γ ( y + 1 )}$$

The resultant distribution is a Gamma distribution with shape parameter a=y+1, and scale parameter s=1.

$$Gamma ( x ; a , s ) = \frac{1}{{s}^{a}} \frac{1}{Γ ( a )} {x}^{a - 1} exp ( - \frac{x}{s} ) , \\ Gamma ( μ ; y + 1 , 1 ) = \frac{{μ}^{y} exp ( - μ )}{Γ ( y + 1 )} .$$

Therefore,

Gamma(μ;y+1,1)=P_{μ}^{cont}(y).

The continuous Poisson distribution P^{cont} can be expressed as an exponential distribution:

$${P}_{μ}^{cont} ( y ) = \frac{{μ}^{y} exp ( - μ )}{Γ ( y + 1 )} = exp \{ y log μ - μ - log ( Γ ( y + 1 ) \}$$

The log-likelihood function L of this distribution is:

$$ℒ ( y ; μ ) = {\sum }_{i} {y}_{i} log {μ}_{i} - {μ}_{i} - log ( Γ ( {y}_{i} + 1 )$$

In order to recover the fluorochrome abundances α the function L is minimized with respect to the regression parameters.

The deviance D can be understood as a generalization of the residual sum of squares used in the case of linear models. Consequently, in the case of the continuous Poisson distribution P^{cont} the deviance is

$$𝒟 ( y , μ ) = 2 ( ℒ ( y ; y ) - ℒ ( y ; μ ) ) = 2 {\sum }_{i} [ {y}_{i} log ( \frac{{y}_{i}}{{μ}_{i}} ) - ( {y}_{i} - {μ}_{i} ) ] \qquad ( 8 )$$

Despite the log function being the canonical link for Poisson generalized linear model, the specific problem of multispectral flow cytometry involves use of identity-link Poisson regression. This is motivated by the fact that the Poisson parameters of the observed fluorescence signal are linear functions of the fluorochrome abundances vector α. Consequently, finding the maximum-likelihood estimates of α involves a Poisson regression with an identity-link function, rather than a log link function. Use of the identity link also means that the simplest and very common approach to a Poisson regression by iterative reweighted least squares often suffers from lack of convergence. The problem can be solved by implementing a modified IRLS approach as discussed by Marschner in Marschner, I. C. (2010) Stable Computation of Maximum Likelihood Estimates in Identity Link Poisson Regression, Journal of Computational and Graphical Statistics 19, 666-683 (the relevant disclosure of which is incorporated by reference). In other embodiments, various approaches to stable computation of maximum-likelihood estimates in identity-link Poisson regression can be utilized in accordance with embodiments of the invention to estimate fluorochrome abundances in accordance with embodiments of the invention.

In several embodiments, following Equations (1) and (8) an identity-link Poisson regression is used in which deviance is expressed as:

$$𝒟 = 2 {j}^{T} ( r ∘ log ( \frac{r}{M α} ) - ( r - M α ) ) , \qquad ( 9 )$$

where j is an L×1 sum vector of 1, and j^{T} is its transpose (the sum vector is used to find the sum of the elements of the computed vector),
log(X) is the element-wise logarithm of X,

$$\frac{x}{y}$$

is the Hadamard division (or element by element division) of vectors x and y, and
the operator o denotes element-wise multiplication (Hadamard product).

In contrast to the least squares approach used with Gaussian regression, the minimization of deviance in the Poisson regression problem has no general closed-form solution. Therefore, the a vector is found using optimization methods such as Nelder and Mead method, Broyden, Fletcher, Goldfarb and Shanno algorithm and others

The minimization of the objective function in Eq. (9) does not guarantee the normegativity of α. Therefore an additional normegativity constraint assuring concordance with the physical model may be imposed.

Furthermore, additional constraints can be used, such as a sum-to-one equivalent constraint can be added as a soft penalty:

$$\hat{α} = arg {min}_{α} \{ 2 {j}^{T} ( r ∘ log ( \frac{r}{M α} ) - ( r - M α ) ) + λ \vert {‖ r ‖}_{1} - {‖ α ‖}_{1} \vert \}$$

$$s . t . α > 0$$

The penalty parameter λ allows control of the level of certainty in the model. This parameter can be set to 0 or to some very low value if the accuracy (or completeness) of M is suspect. In other words, in an experimental setting in which not all the fluorochromes present are known, the entire signal will not be unmixed utilizing only the spectra describing the known fluorochromes. Although specific processes for estimating fluorochrome abundances based upon a Poisson generalized linear model approach are described above, any of a variety of processes based upon a Poisson and/or continuous Poisson signal model can be utilized in accordance with embodiments of the invention.

### Unmixing Processes Using Pearson Residuals

The deviance is not the only measure of goodness of fit employed with generalized linear models. Pearson residuals are another commonly used measure of overall fit for generalized linear models. Pearson residuals are defined to be the standardized difference between the observed and the predicted values. Therefore, the Pearson residual is the raw residual divided by the square root of the variance function

The minimization of the sum of squared Pearson residuals for the Poisson regression problem provides the following approximation of α:

$$\hat{α} = arg {min}_{α} \{ {j}^{T} ( \frac{{( r - M α )}^{2}}{M α} ) \} \qquad s . t . α > 0 ,$$

### Unmixing Processes Involving Variance-Stabilizing Transformations

Unmixing processes in accordance with several embodiments of the invention can perform unmixing of Poisson-distributed measurements using a least squares estimation processes following the transformation of the mixing model into approximately Gaussian. The optimal transformation proposed by Bar-Lev and Enis, or Anscombe and Freeman-Tukey transformations (belonging to a wider class of variance-stabilization functions described by Bar-Lev and Enis), can be used for this purpose.

The Bar-Lev-Enis transformation is defined as

$${𝒜}_{a , b} ( x ) = ( x + 2 a - b ) {( x + a )}^{- \frac{1}{2}} , \\ {𝒜}_{a , b , c} ( x ) = {𝒜}_{a , b} ( x ) + {( x + c )}^{- \frac{1}{2}} .$$

The transformation has been shown to exhibit optimal variance-stabilizing performance for a Poisson distribution for

$$a = \frac{3}{8} + \frac{{3}^{- \frac{1}{2}}}{2} , \qquad b = \frac{3}{8} + \frac{{3}^{\frac{1}{2}}}{4}$$

Therefore, fluorochrome abundance estimates can be obtained by solving the following expression:

$$\hat{α} = arg {min}_{α} {‖ {𝒜}_{a , b} ( r ) - {𝒜}_{a , b} ( M α ) ‖}_{2}^{2} \qquad s . t . α > 0$$

Although a variety of unmixing techniques are described above, any of a variety of techniques for estimating fluorochrome abundances using unmixing processes that account for increases in signal variance with increases in fluorochrome abundances can be utilized in accordance with embodiments of the invention. Systems that utilize unmixing processes in accordance with embodiments of the invention, modifications that can be performed to convention flow cytometers to enhance performance using the unmixing processes, and additional flow cytometer data analysis techniques that are enabled using the residuals generated during the unmixing processes are discussed further below.

### Systems for Analyzing Flow Cytometer Data

Flow cytometry systems including data analysis systems in accordance with embodiments of the invention capture fluorescence emission data for bioparticles labeled with multiple fluorochromes using an over-determined system of detectors. The flow cytometry systems can then utilize an unmixing process that accounts for the increase in signal variance with fluorochrome abundance to estimate fluorochrome abundances with respect to each bioparticle.

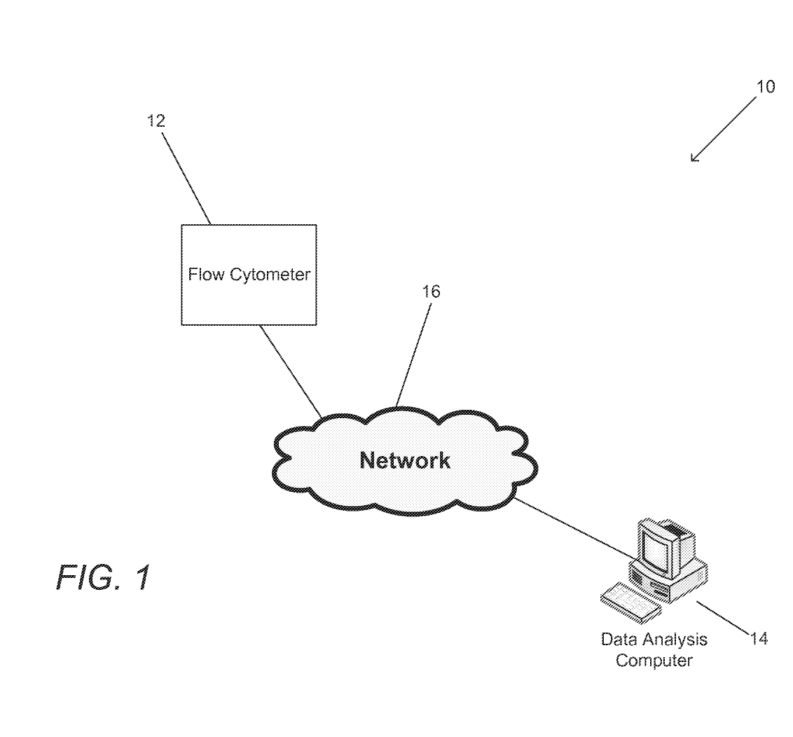

A data analysis system in accordance with an embodiment of the invention is illustrated in FIG. 1. The data analysis system 10 includes a flow cytometer 12. As noted above, the flow cytometer is configured as an over-determined system. Stated another way, the flow cytometer is configured so that the number of signals produced by the detectors is greater than the number of fluorochromes staining the bioparticles observed by the detectors. In many embodiments, the flow cytometer utilizes an optics and detection system to separate optical emission with respect to a predetermined set of spectral ranges using a number of detectors. As can be readily appreciated, any conventional flow cytometer including an appropriate number of detectors can be configured as an over-determined system in accordance with embodiments of the invention. In the illustrated embodiment, the flow cytometer is configured to provide data to a data analysis computer 14 via a network 16. In many embodiments, the data analysis computer is a personal computer, server, and/or any other computing device with the storage capacity and processing power to analyze the data output by the flow cytometer. The analysis computer includes a processor, memory and/or a storage system containing an optical data analysis application that includes machine readable instructions that configures the computer to generate a mixing model from control samples and to apply an unmixing process to fluorescence emission data captured by the flow cytometer based upon the mixing model and the assumption that signal variance in the fluorescence emission data increases with the signal. Although a specific data analysis system is illustrated in FIG. 1, any of a variety of data analysis systems can be utilized to analyze fluorescence emission data captured by a flow cytometer configured as an over-determined system in accordance with embodiments of the invention. In many embodiments, data acquisition systems can be included and/or attached to a flow cytometer and used to perform unmixing processes in accordance with embodiments of the invention.

### Processes for Unmixing Fluorescence Emission Data

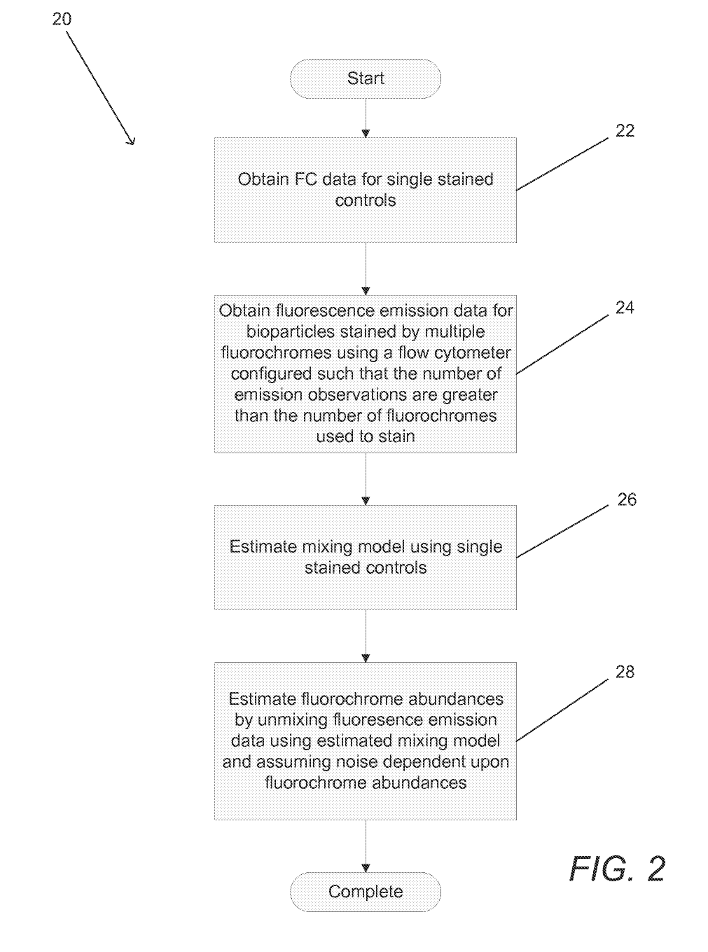

Processes for performing unmixing of fluorescence emission data in ways that account for the relationship between the noise in the fluorescence emission data and the fluorochrome abundances are described extensively above. A process for estimating fluorochrome abundances in accordance with an embodiment of the invention is illustrated in FIG. 2. The process 20 includes obtaining (22) control fluorescence emission data for single stained controls. Fluorescence emission data is obtained (24) for bioparticles stained with multiple fluorochromes. The fluorescence emission data is obtained using a number of detectors configured to produce a number of fluorescence emission observations that is greater than the number of fluorochromes used to stain the bioparticles. The control fluorescence emission data can be obtained using the flow cytometer used to capture the fluorescence emission data. In several embodiments, however, the control fluorescence emission data can be the theoretical spectrum of a fluorochrome, a reference spectrum for a fluorochrome, and/or a spectrum obtained using another instrument.

The control fluorescence emission data is utilized to generate (26) a mixing model, which is used in the estimation of fluorochrome abundances from the fluorescence emission data. In many embodiments, fluorochrome abundances are estimated (28) by performing an unmixing process similar to the unmixing processes described above that account for the increase in the variance in the noise in fluorescence emission data with increased fluorochrome abundance.

Although a specific process is described above with respect to FIG. 2, any of a variety of flow cytometry processes that involve the capture of fluorescence emission data using an over-determined system and the unmixing of the fluorescence emission data using a process that accounts for the increase in the variance in the noise in fluorescence emission data with increased fluorochrome abundance can be utilized in accordance with embodiments of the invention. As can readily be appreciated, the use of unmixing processes in accordance with embodiments of the invention can prompt modification of the conventional manner in which flow cytometers are configured to capture fluorescence emission data and the manner in which data captured by a flow cytometer is analyzed. Techniques for configuring flow cytometers and processes for analyzing fluorescence emission data captured by flow cytometers in accordance with embodiments of the invention are discussed further below.

### Modifying Flow Cytometer Configuration for Over-Determined Operation

The optical pathways employed in majority of current commercial flow cytometers use a set of bandpass and dichroic filters to separate the signal into appropriate wavelength ranges. Fluorescence emission passes through bandpass filters of a desired wavelength or another dichroic filter to be eventually recorded by a photodetector. The resultant electronic signal is then digitized and the digitized value stored. The photodetectors employed are typically photodiodes photomultiplier tubes (PMTs), avalanche photodiodes, or CCD arrays. As noted above, conventional approaches to the detection of fluorescence emission data have involved using fluorochromes with distinct emission peaks and tuning the bandpass filters of the detector system so that a single detector is tuned to detect fluorescence emissions in band corresponding to the emission peak of a single fluorochrome. When the same flow cytometer is configured as an over-determined system in accordance with embodiments of the invention, the effectiveness of the system in estimating fluorochrome abundances can be improved by increasing the bandwidth of the fluorescence emission spectra observed by each of the detectors. Instead of only observing the emission peaks of the individual fluorochromes and discarding the information contained between the peaks, the detector system can be configured to capture as much information concerning the emission spectra of the fluorochromes as is allowed by the instrument. When a flow cytometer is configured in this way, the additional information can be used to increase the accuracy of the estimate of the fluorochrome abundances obtained through the unmixing process.

### Utilizing Residuals in Data Analysis

A feature of using an over-determined system to obtain fluorescence emission data in flow cytometry is that the process of estimating the fluorochrome abundances produces a residual. The residual for a specific bioparticle provides information concerning how well the estimated fluorochrome abundances, multiplied by the mixing matrix, reconstruct the observed fluorescence emission data. This information can be extremely useful as a diagnostic tool. In many embodiments, a data analysis computer can be configured using software that enables the analysis of flow cytometry data using gates that gate the flow cytometry data based upon residuals determined during estimation of fluorochrome abundances. As can be readily appreciated, the ability to analyze subpopulations of bioparticles based upon how well the actual observed values from the detectors match the estimated fluorochrome abundances can be extremely useful in isolating or excluding subpopulations of bioparticles when analyzing flow cytometry data. For example, if a certain subpopulation of cells have estimated observations that are much farther from the true observations than the rest of the population, this likely means that the experimentally determined mixing matrix based on the single stained controls is not appropriate for these cells. As such, there must be additional physiological processes occurring in these cells to render the mixing matrix invalid. The difference between the estimated and true observation can be calculated in many ways, either as a least squares residual, a more generalized deviance or many other techniques used for assessing the difference between two vectors.

While the above description contains many specific embodiments of the invention, these should not be construed as limitations on the scope of the invention, but rather as an example of one embodiment thereof. For example, systems and methods in accordance with embodiments of the invention can be utilized in the unmixing of any optical signal captured by a flow cytometer including but not limited to a fluorescence signal, a Raman signal, and a phosphorescence signal. Accordingly, the scope of the invention should be determined not by the embodiments illustrated, but by the appended claims and their equivalents.

What is claimed is:

1. A data analysis system configured to analyze optical data captured by a flow cytometer with respect to a plurality of particles stained with a plurality of fluorochromes, where an optics and detection system within the flow cytometer separates optical emission with respect to spectral ranges and where at least one detector is used to capture a number of optical measurements that is greater than the plurality of fluorochromes used to stain the plurality of particles, the data analysis system comprising:
a processor;
a memory connected to the processor and configured to store an optical data analysis application, wherein the optical data analysis application configures the processor to:
obtain control optical data for at least one particle stained with at least one fluorochrome selected from a set of fluorochromes, where the control optical data is captured by the flow cytometer configured so that an optics and detection system within the flow cytometer separates optical emission with respect to a predetermined set of spectral ranges;
generate a mixing model using the obtained control optical data and a system of linear combinations;
obtain experimental optical data for particles stained with the set of fluorochromes, where the experimental optical data is captured by the flow cytometer configured so that an optics and detection system within the flow cytometer separates optical emission with respect to the predetermined spectral ranges using at least one detector configured to capture a number of optical measurements and the number of optical measurements is greater than the number of fluorochromes in the set of fluorochromes; and
estimate abundances of the fluorochromes in the set of fluorochromes using the obtained experimental optical data by solving an overdetermined system of equations to unmix the optical data, based upon the generated mixing model that accounts for increased noise variance with increased fluorochrome abundance.

2. The data analysis system of claim 1, wherein the optical data analysis application further configures the processor to obtain control optical data for the at least one particle stained using a single fluorochrome selected from the set of fluorochromes.

3. The data analysis system of claim 1, wherein the optical data can be captured from optical signals that can be selected from the group consisting of fluorescence signals, Raman signals, and phosphorescence signals.

4. The data analysis system of claim 1, wherein each of the number of detectors are tuned to capture optical emissions over a spectrum as wide as allowed by the flow cytometer.

5. The data analysis system of claim 1, wherein the optical data analysis application further configures the processor to estimate fluorochrome abundances by utilizing a percentage error estimation via a weighted least squares method.

6. The data analysis system of claim 1, wherein the optical data analysis application further configures the processor to estimate fluorochrome abundances by utilizing a percentage errors minimization process.

7. The data analysis system of claim 6, wherein the optical data analysis application further configures the processor to estimate fluorochrome abundances by utilizing a mean absolute percentage errors minimization process using:
\hat{α}=(M^{T}W²M)⁻¹M^{T}W₂r
where \hat{α} is a vector of length p of the estimated fluorochrome abundances where p is the number of fluorochromes used to stain the particles, M is an L×p spectral-signature matrix where L is the number of optical data observations and p is the number of fluorochromes used to stain the particles, M^{T} is the transpose of the matrix M, r is a normalized vector of length L of optical data observations, and W is a diagonal matrix with 1/rⱼ values such that:
$$W = ( \begin{matrix}\frac{1}{{r}_{1}} & 0 & 0 \\ 0 & ⋱ & 0 \\ 0 & 0 & \frac{1}{{r}_{L}}\end{matrix} )$$

8. The data analysis system of claim 1, wherein the optical data analysis application further configures the processor to estimate fluorochrome abundances by utilizing a maximum likelihood-based Poisson regression using:
$$\hat{α} = arg {min}_{α} \{ 2 {j}^{T} ( r ∘ log ( \frac{r}{M α} ) - ( r - M α ) ) + λ \vert {‖ r ‖}_{1} - {‖ α ‖}_{1} \vert \}$$
$$s . t . α > 0$$
where \hat{α} is a vector of length p of the estimated fluorochrome abundances where p is the number of fluorochromes used to stain the particles, j is an L×1 sum vector of 1 where L is the number of optical data observations, and j^{T} is the transpose of the vector j, r is a normalized vector of length L of optical data observations, operator o denotes element-wise multiplication, α is a vector of length p of fluorochrome abundances where p is the number of fluorochromes used to stain the particles, M is an L×p spectral-signature matrix where L is the number of optical data observations and p is the number of fluorochromes used to stain the particles, and λ is a penalty parameter that allows for control of the level of certainty in the model.

9. The data analysis system of claim 1, wherein the optical data analysis application further configures the processor to estimate fluorochrome abundances by minimizing Pearson residuals using:
$$\hat{α} = arg {min}_{α} \{ {j}^{T} ( \frac{{( r - M α )}^{2}}{M α} ) \} \qquad s . t . α > 0 ,$$
where \hat{α} is a vector of length p of the estimated fluorochrome abundances where p is the number of fluorochromes used to stain the particles, j is an L×1 sum vector of 1 where L is the number of optical data observations, and j^{T} is the transpose of the vector j, and M is an L×p spectral-signature matrix where L is the number of optical data observations and p is the number of fluorochromes used to stain the particles.

10. The data analysis system of claim 1, wherein the optical data analysis application further configures the processor to estimate fluorochrome abundances by utilizing a Bar-Lev/Enis class of transformations and using:
$$\hat{α} = arg {min}_{α} {‖ {𝒜}_{a , b} ( r ) - {𝒜}_{a , b} ( M α ) ‖}_{2}^{2} \qquad s . t . α > 0$$
where \hat{α} is a vector of length p of the estimated fluorochrome abundances where p is the number of fluorochromes used to stain the particles, r is a normalized vector of length L of optical data observations, M is an L×p spectral-signature matrix where L is the number of optical data observations and p is the number of fluorochromes used to stain the particles, α is the vector of length p where p is the number of fluorochromes used to stain the particles, and the Bar-Lev/Enis transformation is defined as:
$${𝒜}_{a , b} ( x ) = ( x + 2 a - b ) {( x + a )}^{- \frac{1}{2}} , \\ {𝒜}_{a , b , c} ( x ) = {𝒜}_{a , b} ( x ) + {( x + c )}^{- \frac{1}{2}} .$$

11. The data analysis system of claim 1, wherein the processor being configured by the data analysis application to use an unmixing process that accounts for increased noise variance with increased fluorochrome abundance further comprises using a regression process in which a distance metric applied to a given optical measurement is weighted by a function of the given optical measurement.

12. The data analysis system of claim 11, wherein the regression process is based upon a noise model selected from the group consisting of Poisson distributed noise, gamma distributed noise, Pólya distributed noise, and negative binomial distributed noise.

13. The data analysis system of claim 1, wherein the processor being configured by the data analysis application to use an unmixing process that accounts for increased noise variance with increased fluorochrome abundance further comprises using a regression process in which a distance metric applied to a given optical measurement is weighted by a function of the predicted value for the given optical measurement.

14. The data analysis system of claim 13, wherein the data analysis application utilizes an iterative percentage errors minimization process.

15. The data analysis system of claim 1, wherein the least one detector configured to capture a number of optical measurements are multiple CCD detectors.

16. The data analysis system of claim 1, wherein the least one detector configured to capture a number of optical measurements is a single CCD array detector.

17. A method for analyzing optical data captured by a flow cytometer with respect to a plurality of particles stained with a plurality of fluorochromes, where an optics and detection system within the flow cytometer separates optical emission with respect to spectral ranges and where at least one detector is used to capture a number of optical measurements that is greater than the plurality of fluorochromes used to stain the plurality of particles, using a data analysis system, the method comprising:
obtaining control optical data for at least one particle stained with at least one fluorochrome selected from a set of fluorochromes using the data analysis system, where the control optical data is captured utilizing the flow cytometer configured so that an optics and detection system within the flow cytometer separates optical emission with respect to a predetermined set of spectral ranges;
generating a mixing model using the obtained control optical data and a system of linear combinations using the data analysis system;
obtaining experimental optical data for particles stained with the set of fluorochromes using the data analysis system, where the experimental optical data is captured utilizing the flow cytometer configured so that an optics and detection system within the flow cytometer separates optical emission with respect to the predetermined spectral ranges using at least one detector configured to capture a number of optical measurements and the number of optical measurements is greater than the number of fluorochromes in the set of fluorochromes; and
estimating abundances of the fluorochromes in the set of fluorochromes using the obtained experimental optical data by solving an overdetermined system of equations to unmix the optical data using the data analysis system, based upon the generated mixing model that accounts for increased noise variance with increased fluorochrome abundance.

18. The method of claim 17, wherein the obtaining control optical data for at least one particle stained with at least one fluorochrome selected from a set of fluorochromes using the data analysis system further comprises selecting a single fluorochrome from the set of fluorochromes using the data analysis system.

19. The method of claim 17, wherein the optical data can be captured from optical signals that can be selected from the group consisting of fluorescence signals, Raman signals, and phosphorescence signals using the data analysis system.

20. The method of claim 17, wherein each of the number of detectors are tuned to capture optical emissions over a spectrum as wide as allowed by the flow cytometer using the data analysis system.

21. The method claim 17, wherein the estimating abundances of the fluorochromes in the set of fluorochromes using the data analysis system further comprises utilizing a percentage error estimation via a weighted least squares method using the data analysis system.

22. The method of claim 17, wherein the estimating abundances of the fluorochromes in the set of fluorochromes using the data analysis system further comprises utilizing a percentage errors minimization process using the data analysis system.

23. The method of claim 22, wherein the estimating abundances of the fluorochromes in the set of fluorochromes using the data analysis system further comprises using the data analysis system to utilize a mean absolute percentage error minimization process and a formula defined such that:
\hat{α}=(M^{T}W²M)⁻¹M^{T}W²r
where \hat{α} is a vector of length p of the estimated fluorochrome abundances where p is the number of fluorochromes used to stain the particles, M is an L×p spectral-signature matrix where L is the number of optical data observations and p is the number of fluorochromes used to stain the particles, M^{T} is the transpose of the matrix M, r is a normalized vector of length L of optical data observations, and W is a diagonal matrix with 1/rⱼ values such that:
$$W = ( \begin{matrix}\frac{1}{{r}_{1}} & 0 & 0 \\ 0 & ⋱ & 0 \\ 0 & 0 & \frac{1}{{r}_{L}}\end{matrix} )$$

24. The method of claim 17, wherein the estimating abundances of the fluorochromes in the set of fluorochromes using the data analysis system further comprises using the data analysis system to utilize a maximum likelihood-based using a Poisson regression and a formula defined such that:
$$\hat{α} = arg {min}_{α} \{ 2 {j}^{T} ( r ∘ log ( \frac{r}{M α} ) - ( r - M α ) ) + λ \vert {‖ r ‖}_{1} - {‖ α ‖}_{1} \vert \}$$
$$s . t . α > 0$$
where \hat{α} is a vector of length p of the estimated fluorochrome abundances where p is the number of fluorochromes used to stain the particles, j is an L×1 sum vector of 1 where L is the number of optical data observations, and j^{T} is the transpose of the vector j, r is a normalized vector of length L of optical data observations, operator o denotes element-wise multiplication, α is a vector of length p of fluorochrome abundances where p is the number of fluorochromes used to stain the particles, M is an L×p spectral-signature matrix where L is the number of optical data observations and p is the number of fluorochromes used to stain the particles, and λ is a penalty parameter that allows for control of the level of certainty in the model.

25. The method of claim 17, wherein the estimating abundances of the fluorochromes in the set of fluorochromes using the data analysis system further comprises using the data analysis system to minimize Pearson residuals and to utilize a formula defined such that:
$$\hat{α} = arg {min}_{α} \{ {j}^{T} ( \frac{{( r - M α )}^{2}}{M α} ) \} \qquad s . t . α > 0 ,$$
where \hat{α} is a vector of length p of the estimated fluorochrome abundances where p is the number of fluorochromes used to stain the particles, j is an L×1 sum vector of 1 where L is the number of optical data observations, and j^{T} is the transpose of the vector j, and M is an L×p spectral-signature matrix where L is the number of optical data observations and p is the number of fluorochromes used to stain the particles.

26. The method of claim 17, wherein the estimating abundances of the fluorochromes in the set of fluorochromes using the data analysis system further comprises using the data analysis system to utilize a Bar-Lev/Enis class of transformations and a formula such that:
$$\hat{α} = arg {min}_{α} {‖ {𝒜}_{a , b} ( r ) - {𝒜}_{a , b} ( M α ) ‖}_{2}^{2} \qquad s . t . α > 0$$
where \hat{α} is a vector of length p of the estimated fluorochrome abundances where p is the number of fluorochromes used to stain the particles, r is a normalized vector of length L of optical data observations, M is an L×p spectral-signature matrix where L is the number of optical data observations and p is the number of fluorochromes used to stain the particles, α is the vector of length p where p is the number of fluorochromes used to stain the particles, and the Bar-Lev/Enis transformation is defined as:
$${𝒜}_{a , b} ( x ) = ( x + 2 a - b ) {( x + a )}^{- \frac{1}{2}} , \\ {𝒜}_{a , b , c} ( x ) = {𝒜}_{a , b} ( x ) + {( x + c )}^{- \frac{1}{2}} .$$

27. The method of claim 17, wherein the processor being configured by the data analysis application to use an unmixing process that accounts for increased noise variance with increased fluorochrome abundance further comprises using a regression process in which a distance metric applied to a given optical measurement is weighted by a function of the given optical measurement.

28. The method of claim 27, wherein the regression process is based upon a noise model selected from the group consisting of Poisson distributed noise, gamma distributed noise, Pólya distributed noise, and negative binomial distributed noise.

29. The method of claim 17, wherein the processor being configured by the data analysis application to use an unmixing process that accounts for increased noise variance with increased fluorochrome abundance further comprises using a regression process in which a distance metric applied to a given optical measurement is weighted by a function of the predicted value for the given optical measurement.

30. The method of claim 29, wherein the data analysis application further utilizes an iterative percentage errors minimization process.

31. The method of claim 17, wherein the least one detector configured to capture a number of optical measurements further comprises multiple CCD detectors.

32. The method of claim 17, wherein the least one detector configured to capture a number of optical measurements further comprises a single CCD array detector.
